(19) United States
(12) Patent Application Publication
(10) Pub. No.: US 2024/0335964 A1
(43) Pub. Date: Oct. 10, 2024

(54) MOUNTING ASSEMBLY FOR A HAIR CUTTING APPLIANCE

(71) Applicant: KONINKLIJKE PHILIPS N.V., EINDHOVEN (NL)

(72) Inventors: MARCUS CORNELIS PETRELLI, GRONINGEN (NL); RAMACHANDRA GANESH RAO, GRONINGEN (NL)

(21) Appl. No.: 18/574,515

(22) PCT Filed: Jun. 29, 2022
(86) PCT No.: PCT/EP2022/067898

§ 371 Date: Dec. 27, 2023

(30) Foreign Application Priority Data
Jul. 2, 2021 (EP) 21183450.2

(51) Int. Cl. B26B 19/38; B26B 19/04

(52) U.S. Cl. CPC B26B 19/386; B26B 19/048

(57) ABSTRACT

According to an aspect, there is provided a mounting assembly (10) for a hair cutting appliance, the mounting assembly comprising: a head (12) configured to receive a cutting unit; and a base (14), wherein the head is mounted to the base via a pair of arms (16) to form a linkage. Each arm is coupled at a joint (18) to a head coupling (20) on the head, and coupled at a joint to a respective base coupling (22) on the base. The base couplings are spaced apart along a movement line, and each joint is configured to permit pivoting movement about parallel pivot axes. A stroke limiter (26) is configured to obstruct pivoting movement of the head relative to the base beyond a limit. At least one of the base couplings is a flexible base coupling which is elastically mounted to a body (38) of the base such that the respective flexible base coupling is moveable relative to the body in a direction having a component which is parallel to the movement line and away from the other base coupling, to permit pivoting movement of the head relative to the base beyond the limit imposed by the stroke limiter.

### FIELD OF THE INVENTION

The invention relates to a mounting assembly for a hair cutting appliance, and a hair cutting appliance comprising the mounting assembly.

### BACKGROUND OF THE INVENTION

Hair cutting appliances, such a manual or electric razors typically have a blade head mounted to a handle, and the blade head may be pivotably attached to the handle to rotate relative to the body about an axis, such as WO 2015/074882. However, such pivoting movement may have a hard stop providing a sudden limit to the pivoting movement of the head, which is unpleasant for the user and can result in poor cutting performance on complex geometries such as faces.

### SUMMARY OF THE INVENTION

According to a first specific aspect, there is provided a mounting assembly for a hair cutting appliance, the mounting assembly comprising: a head configured to receive a cutting unit: a base, wherein the head is mounted to the base via a pair of arms to form a linkage, each arm being coupled at a joint to a head coupling on the head, and coupled at a joint to a respective base coupling on the base, the base couplings spaced apart along a movement line, and each joint configured to permit pivoting movement about parallel pivot axes: a stroke limiter configured to obstruct pivoting movement of the head relative to the base beyond a limit: wherein at least one of the base couplings is a flexible base coupling which is elastically mounted to a body of the base such that the respective flexible base coupling is moveable relative to the body in a direction having a component which is parallel to the movement line and away from the other base coupling, to permit pivoting movement of the head relative to the base beyond the limit imposed by the stroke limiter.

The pivoting movement of the head relative to the base may include the head pivoting about a virtual axis, which is parallel to the pivot axes.

Each arm may be coupled to a different respective head coupling to permit pivoting movement about different parallel pivot axes thereby forming a four-bar linkage, such that the head is pivotably moveable relative to the base. The stroke limiter may be configured to obstruct pivoting movement of the four-bar linkage to thereby inhibit pivoting movement of the head relative to the base beyond the limit.

The stroke limiter may comprise a tab protruding from the head, the tab being arranged to engage with at least one of the arms to obstruct movement of the four-bar linkage within the movement plane.

The mounting assembly may comprise a primary spring which is configured to engage with the arms to bias the four-bar linkage to the limit.

Both base couplings on the handle may be flexible base couplings.

Each flexible base coupling may be mounted to the body of the base on a cantilevered elastic beam which permits movement of the base coupling relative to the body in the direction having a component which is parallel to the movement line and away from the other base coupling.

The body may comprise a stop for each flexible base coupling, wherein the stop may be configured to abut the elastic beam to limit movement of the elastic beam in a direction towards the other base coupling.

The base may further comprise a pretension spring which is configured to bias the elastic beam for each flexible base coupling towards the stop.

The pretension spring may be configured to bias the flexible base coupling to abut the stop.

The stiffness of the pretension spring may be higher than the stiffness of the elastic beam in the movement plane.

Each base coupling may be a ball bearing configured to cooperate with a corresponding ball socket on the respective arm.

The base couplings may be spaced apart and aligned within the movement plane.

Each flexible base coupling may be moveable relative to the body such that the base couplings move only within a single plane. In other words, the elastic beam on which the flexible base coupling is mounted may not permit movement in a direction parallel to the pivot axes.

According to a second aspect, there is provided a hair cutting appliance comprising a mounting assembly according to the first aspect.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 schematically shows a cross-sectional view of an example mounting assembly for a hair cutting appliance;

FIG. 2 shows an exploded isometric view of the example mounting assembly of FIG. 1; and

FIG. 3 schematically shows a cross-sectional view of the mounting assembly extending beyond a stroke limit.

### DETAILED DESCRIPTION OF THE EMBODIMENTS

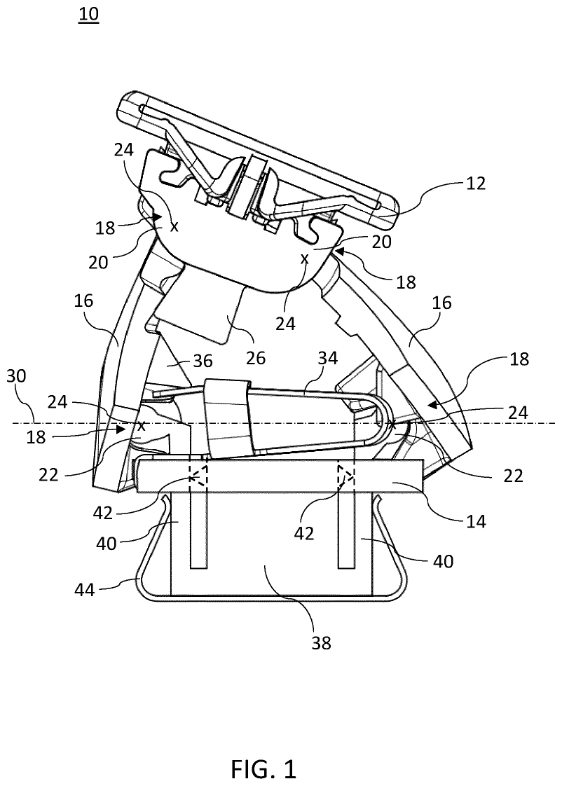

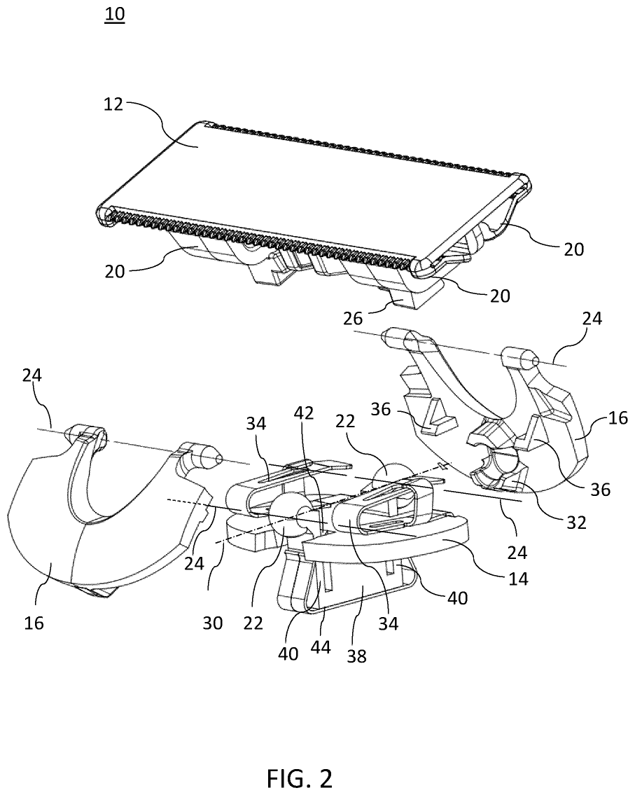

FIG. 1 shows a cross-sectional view of an example mounting assembly 10 for a hair cutting appliance, in a first position. FIG. 2 shows an exploded isometric view of the same mounting assembly 10.

The mounting assembly 10 comprises a head 12 which is configured to receive a cutting unit, such as a blade or electric trimming attachment, and a base 14 for connection to a handle configured to be held by a user. In some examples, the base may be integral with a handle.

The head 12 is mounted to the base 14 via a pair of arms 16. Each arm 16 is connected at a joint 18 to respective head couplings 20 and connected at a joint 18 to respective base couplings 22.

In this example, the arms 16 each comprise two diverging strands in a U-shape such that each arm 16 is connected to the base 14 at a single base coupling 22 at the apex of the U-shape, and such that each arm 16 is connected at the two ends of the U-shape to a respective head coupling 20. Therefore, there are two base couplings 22 on the base 14, and there are four head couplings 20 on the head 12. The head 12 is supported relative to the base 14 by the four head couplings 20 which connect to the arms 16.

In other examples, each arm may comprise a single strand to form an I-shape such that the head is supported by the arms at only two head couplings in total, or the arms may comprise more than two diverging strands so that the coupler link is supported by the arms at more than two coupler joins per arm. Each arm may have a different number of diverging strands to support the coupler link at, for example 3 or 5 coupler joins. In yet further examples, the arms may comprise two diverging strands in the form of a T, V or Y shape such that each arm supports the coupler link at two coupler joins.

Each joint 18 is configured to permit pivoting movement between the respective arms 16, head 12 and base 14, about parallel primary pivot axes 24 (shown as going into the page on FIG. 1) to form a four-bar linkage in which each arm 16 is one bar, the head 12 is one bar and the base 14 is one bar of the four-bar linkage. The four-bar linkage is therefore permitted to move within a movement plane which is perpendicular to the primary pivot axes 24.

In this example, the two head couplings 20 connecting the same arm 16 to the head 12 are spaced apart only in a direction parallel to the primary pivot axes 24 such that they share a primary pivot axis 24 (i.e. their pivot axes are collinear). The head couplings 20 connecting different arms 16 to the head 12 are spaced apart within the movement plane (i.e. perpendicular to the primary pivot axes 24), such that the joint 18 at head couplings 20 for different arms 16 each permit pivoting movement about different parallel primary pivot axes 24. The base couplings 22 are also spaced apart within the movement plane along a movement line, which in this example is the secondary pivot axis 30. The four-bar linkage therefore permits pivoting movement of the head 12 relative to the base 14 about a virtual pivot axis, where the virtual pivot axis is parallel to the primary pivot axes 24 of the joints 18.

In other examples, the pivot axes of all of the joints at the head couplings are collinear, so that the head no longer forms a bar of the linkage, and such that the arms, head and base form a three-bar linkage. In such examples, the head is pivotable about the primary pivot axis which passes through the head couplings.

Each of the head couplings 20 in this example are linear bearings, and so only permit pivoting movement about the parallel primary pivot axes 24 within the movement plane. Each of the base couplings 22 in this example are ball bearings which are configured to cooperate with a corresponding ball socket 32 on the respective arms 16 to form a ball joint (best shown in FIG. 2). The ball joints permit pivoting movement about three perpendicular pivot axes. However, due to the four-bar linkage, the ball joints (i.e. the joints 18 at the base couplings 22 in this example), are constrained to permit pivoting movement about only their respective primary pivot axes 24, and a secondary pivot axis 30 within the movement plane, which passes through both base couplings 22. The secondary pivot axis 30 permits movement of the whole four-bar linkage in unison such that the primary pivot axes 24 also pivot about the secondary pivot axis 30, thereby also pivoting the movement plane about the secondary pivot axis 30.

In some examples, the ball bearings may be linear bearings such that there is no pivoting movement about a secondary pivot axis. It will be appreciated that in other examples, the ball bearing may be disposed on the head and the linear bearings may be disposed on the base.

The mounting assembly 10 comprises a stroke limiter 26 which is configured to obstruct pivoting movement of the head relative to the base beyond a limit. In this example, the stroke limiter 26 is configured to obstruct pivoting movement of the four-bar linkage to inhibit pivoting movement of the head 12. In other examples, when the linkage is a three-bar linkage, the stroke limiter may merely limit pivoting movement of the head about the primary pivot axis passing through the head coupling.

The stroke limiter 26 in this example comprises a tab protruding from the head 12 in a direction towards the base 14, such that the tab is disposed between the pair of arms 16. The tab is arranged to engage with each of the arms 16 at a respective limit to obstruct movement of the four-bar linkage within the movement plane. FIG. 1 shows the tab engaged with one of the arms 16 at a limit. The four-bar linkage is therefore constrained to move within the movement plane between limits imposed by the stroke limiter 26 engaging with each arm 16.

It will be appreciated that the tab may be disposed on the head outside the arms and may be configured to engage the outside of one of the arms to obstruct movement of the four-bar linkage beyond a limit. In other examples, the tab may be disposed on one of the arms or on the base and may be configured to engage with the head or the base to obstruct pivoting movement of the four-bar linkage or pivoting movement of the head. The stroke limiter may only obstruct pivoting movement of the head in one direction, or may obstruct pivoting movement of the head in both pivoting directions.

The mounting assembly 10 further comprises a pair of primary springs 34 in this example which are attached to the base 14 and are each configured to engage with one of the arms 16 to bias the four-bar linkage to one of the limits (i.e. to the first position shown in FIG. 1). In this example, each primary spring 34 comprises a leaf spring which abuts an inner protrusion 36 on one of the arms 16 to push the protrusion 36 upwards. Both protrusions 36 are on the same arm 16 and therefore the primary springs 34 both act in unison to pivot the arm 16 until the stroke limiter 26 obstructs further pivoting movement at a limit in the first position, in this example, by engaging the same arm 16.

The primary springs 34 are spaced apart along a direction parallel to the primary pivoting axis 24 (i.e. they are disposed on either side of the movement plane). It will be appreciated that only one primary spring is necessary to provide the biasing force to bias the head to the first position shown in FIG. 1, and that there may be no primary springs to bias the head to the first position. It will also be appreciated that the primary springs may be disposed elsewhere, such as on the arms or the head, to bias the four-bar linkage to the limit.

In this example, the base couplings 22 are flexible base couplings 22 which are mounted to the body 38 of the base 14 on a cantilevered elastic beam 40 and moveable to a second position.

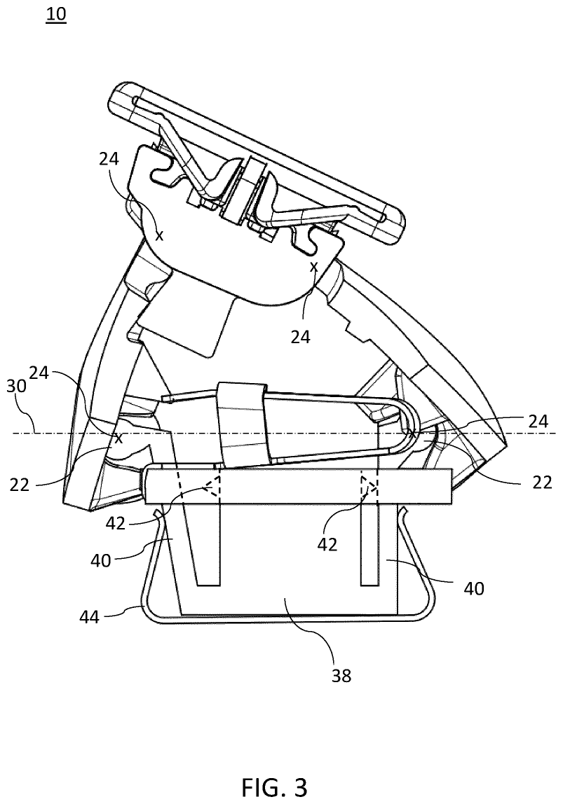

FIG. 3 shows the mounting assembly 10 of FIG. 1 in the second position. The elastic beam 40 is attached at one end to the body 38, and the base coupling 22 (i.e. the ball bearing) is mounted to the other end of the clastic beam 40 to form the flexible base coupling 22. The elastic beam 40 therefore permits movement of the flexible base coupling 22 relative to the base body 38 in a direction having a component which is parallel to the movement line (i.e. the secondary pivot axis 30 in this example), to the second position, on application of an external force. In the second position, the primary pivot axis 24 of the joint 18 has moved with the flexible base coupling 22. It will be appreciated that in some examples, there may be only one flexible base coupling.

In this example, the elastic beam 40 permits movement only in a single plane. In other words, the stiffness of the elastic beam 40 prevents movement of the flexible base coupling 22 in a direction out of the single plane. In some examples, the clastic mounting of the base coupling to the base may permit movement of the flexible base only within the movement plane, such as movement along the secondary pivot axis, for example, if the elastic mounting is in the form of a simple linear spring, such as a coil spring.

When the head 12 is biased to a limit by the primary spring 34 or moved to a limit by an external force, the stroke limiter 26 obstructs movement of the head 12 relative to the base 14 beyond the limit (as shown in FIG. 1). If further external force is applied, one of the flexible base couplings 22 is forced to move within the single plane from the first position, towards the second position in a direction having a component which is parallel to the movement line, which is away from the other base coupling 22. This makes the bar of the four-bar linkage defined by the base 14 longer, thereby changing the layout of the four-bar linkage and permitting pivoting movement of the head 12 relative to the base 14 beyond the limit imposed by the stroke limiter 26. Having this arrangement provides a soft stop to the pivoting movement of the head 12 relative to the base 14 when an external force is applied to the head 12, such as when the head 12 is applied to skin for shaving. Further, having an arrangement in which both base couplings 22 are flexible base couplings 22 can act as a suspension unit, when excessive force is applied to the head 12 in the direction of the base 14, the flexible base couplings 22 can both move to provide some suspension. This can improve user comfort.

Referring back to FIGS. 1-3, in this example, the body 38 of the base 14 comprises a stop 42 for each flexible base coupling 22. Therefore, the base 14 comprises two stops 42, which are on opposing sides of the body 38. Each stop 42 is configured to abut the elastic beam 40 on which the respective base coupling 22 is mounted (or obstruct any other flexible mounting) to limit movement of the elastic beam 40 in a direction towards the other base coupling 22.

In this example, the base 14 further comprises a pretension spring 44 which is configured to bias the elastic beam 40, and thereby the flexible base coupling 22, towards the stop 42, to abut the stop 42. In this example, the pretension spring is in the form of a clip which is disposed around the stops 42, and acts on both stops 42 from opposing sides. In other examples, each stop may have its own pretension spring which limits movement of the flexible mounting.

In this example, the pretension spring 44 has a higher stiffness than the elastic beam 40 in the single plane in which the flexible base couplings 22 are configured to move, such that it provides a smooth transition of movement for the head 12 beyond the limit imposed by the stroke limiter 26.

It will be appreciated that in some examples, the base coupling may be mounted on a beam which is pivotably mounted to the body of the base, and the pretension spring may provide the elastic movement of the base coupling.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A mounting assembly for a hair cutting appliance, the mounting assembly comprising:
a head configured to receive a cutting unit;
a base, wherein the head is mounted to the base via a pair of arms to form a linkage, each arm being coupled at a joint to a head coupling on the head, and coupled at a joint (18) to a respective base coupling on the base, the base couplings spaced apart along a movement line, and each joint configured to permit pivoting movement about parallel pivot axes;
a stroke limiter configured to obstruct pivoting movement of the head relative to the base beyond a limit;
wherein at least one of the base couplings is a flexible base coupling which is elastically mounted to a body of the base such that the respective flexible base coupling is moveable relative to the body in a direction having a component which is parallel to the movement line and away from the other base coupling, to permit pivoting movement of the head relative to the base beyond the limit imposed by the stroke limiter.

2. A mounting assembly according to claim 1, wherein each arm is coupled to a different respective head coupling to permit pivoting movement about different parallel pivot axes thereby forming a four-bar linkage, such that the head is pivotably moveable relative to the base;
wherein the stroke limiter is configured to obstruct pivoting movement of the four-bar linkage to thereby inhibit pivoting movement of the head relative to the base beyond the limit.

3. A mounting assembly according to claim 2, wherein the stroke limiter comprises a tab protruding from the head, the tab being arranged to engage with at least one of the arms to obstruct movement of the four-bar linkage within the movement plane.

4. A mounting assembly according claim 2, comprising a primary spring which is configured to engage with the arms to bias the four-bar linkage to the limit.

5. A mounting assembly according to claim 1, wherein both base couplings on the handle are flexible base couplings.

6. A mounting assembly according to claim 1, wherein each flexible base coupling is mounted to the body of the base on a cantilevered elastic beam which permits movement of the base coupling relative to the body in the direction having a component which is parallel to the movement line and away from the other base coupling.

7. A mounting assembly according to claim 6, wherein the body comprises a stop for each flexible base coupling, wherein the stop is configured to abut the elastic beam to limit movement of the elastic beam in a direction towards the other base coupling.

8. A mounting assembly according to claim 7, wherein the base further comprises a pretension spring which is configured to bias the elastic beam for each flexible base coupling towards the stop.

9. A mounting assembly according to claim 8, wherein the pretension spring is configured to bias the flexible base coupling to abut the stop.

10. A mounting assembly according to claim 8, wherein the stiffness of the pretension spring is higher than the stiffness of the elastic beam in the movement plane.

11. A mounting assembly according to claim 1, wherein each base coupling is a ball bearing configured to cooperate with a corresponding ball socket on the respective arm.

12. A mounting assembly according to claim 1, wherein each flexible base coupling is moveable relative to the body such that the base couplings move only within a single plane.

13. A hair cutting appliance comprising a mounting assembly according to claim 1.
